(19) United States
(12) Patent Application Publication
(10) Pub. No.: US 2025/0160357 A1
(43) Pub. Date: May 22, 2025

(54) CHEESE-LIKE FOOD AND METHOD FOR MANUFACTURING SAME

(71) Applicant: MEIJI CO., LTD., Tokyo (JP)

(72) Inventor: Takahiro HANAFUSA, Tokyo (JP)

(73) Assignee: MEIJI CO., LTD., Tokyo (JP)

(21) Appl. No.: 18/841,798

(22) PCT Filed: Feb. 27, 2023
(86) PCT No.: PCT/JP2023/006899

§ 371 Date: Aug. 27, 2024

(30) Foreign Application Priority Data
Feb. 28, 2022 (JP) 2022-029689

(51) Int. Cl. A23C 20/00; A23C 19/055

(52) U.S. Cl. CPC A23C 20/00; A23C 19/055

(57) ABSTRACT

Provided is a cheese-like food having a protein content of 13 mass % or less, wherein the abundance ratio of fat globules each having a diameter of from 7 μm to 19 μm is 30% or more, and the abundance ratio of fat globules each having a diameter of 20 μm or more thereto is less than 8%, relative to the entirety of fat globules in the cheese-like food.

### TECHNICAL FIELD

The present invention relates to a cheese-like food and a method of manufacturing the food.

### BACKGROUND ART

The price of cheese has tended to increase owing to the tight supply and demand of raw milk serving as a raw material for the cheese, the soaring of the price of the raw milk, and an increase in manufacturing cost therefor. In addition, some kinds of cheese have high fat contents or high salt contents. In, for example, consideration of persons suffering from lifestyle-related diseases, such as hyperlipidemia and pre-hyperlipidemia, and hypertension and pre-hypertension, there has been a growing demand for a cheese-like food having flavor and mouthfeel similar to those of the cheese. Further, it has been reported that dairy products obtained from cattle, sheep, and the like have large environmental loads, and hence a demand for the cheese-like food has started to increase from the viewpoint of alleviating the environmental loads.

For example, in Patent Literature 1, there are disclosures of: “a cheese-like food, in which the content of a cheese raw material is less than 10 mass %, which includes 8 mass % to 30 mass % of a milk protein concentrate, 5 mass % to 35 mass % of an oil and fat, and 0.2 mass % to 2 mass % of a molten salt, in which the total of the milk protein concentrate, and the oil and fat is 35 mass % or more, in which a solid content is from 44 mass % to 60 mass %, and in which the mass ratio of a lipid to a protein is from 0.3 to 3.1;” and a method of manufacturing a cheese-like food, the method including heating and melting all raw materials having such composition, molding the resultant heated emulsion, and cooling the resultant molded product.

In Patent Literature 2, there is a disclosure of “a method of manufacturing a cheese-like food, the method including the steps of: mixing raw materials, which contain rennet casein and agar, and which are free of any cheese; and heating and melting the resultant mixture, followed by the adjustment of its pH.”

### CITATION LIST

### Patent Literature

[PTL 1] WO 2019/234957 A1
[PTL 2] WO 2020/218428 A1

### SUMMARY OF INVENTION

In consideration of a demand for a cheese-like food, to provide a cheese-like food particularly suitable for use in food to be cooked with heat, the inventors of the present invention have made extensive investigations with a view to further improving the related art.

An object of the present invention is to provide a cheese-like food, which is reduced in environmental load, and is excellent in stringiness and heat-melting property, and a method of manufacturing such cheese-like food at low cost and with high production efficiency.

According to the present invention, there can be provided the following cheese-like food and the like.

1. A cheese-like food, including fat globules,
wherein an abundance ratio of fat globules each having a diameter of from 7 μm to 19 μm is 30% or more, and an abundance ratio of fat globules each having a diameter of 20 μm or more thereto is less than 8%, relative to an entirety of the fat globules in the cheese-like food.

2. The cheese-like food according to Item 1, wherein a protein content of the cheese-like food is 13 mass % or less.

3. The cheese-like food according to Item 1 or 2, wherein an oil off of the cheese-like food is from 0.4 mass % to 8 mass %.

4. A method of manufacturing a cheese-like food, including the steps of:
loading a vegetable oil and fat into a melting apparatus;
loading another raw material except water into the melting apparatus;
stirring contents of the melting apparatus to disperse the another raw material in the vegetable oil and fat;
adding water to the contents of the melting apparatus under a state in which the stirring is stopped;
and heating the contents of the melting apparatus, while stirring the contents, to melt the contents.

5. The manufacturing method according to Item 4, wherein an abundance ratio of fat globules each having a diameter of from 7 μm to 19 μm is 30% or more, and an abundance ratio of fat globules each having a diameter of 20 μm or more thereto is less than 8%, relative to an entirety of fat globules in the cheese-like food.

6. The manufacturing method according to Item 4 or 5, wherein a protein content of the cheese-like food is 13 mass % or less.

7. The manufacturing method according to any one of Items 4 to 6, wherein the another raw material is a powdery or solid raw material.

8. The manufacturing method according to any one of Items 4 to 7, wherein the another raw material is rennet casein, sodium caseinate, and modified starch.

9. The manufacturing method according to any one of Items 4 to 8, wherein the another raw material further contains natural cheese.

According to the present invention, the cheese-like food, which is reduced in environmental load, and is excellent in stringiness and heat-melting property, and the method of manufacturing such cheese-like food at low cost and with high production efficiency, can be provided.

### BRIEF DESCRIPTION OF DRAWINGS

FIG. 1 is the photograph showing criteria for the evaluation of a heat-melting property.

FIG. 2 is the photograph showing criteria for the evaluation of the heat-melting property.

FIG. 3 is the photograph showing criteria for the evaluation of shredding suitability.

### DESCRIPTION OF EMBODIMENTS

The embodiments of a cheese-like food of the present invention and a method of manufacturing the food are described below. The present invention is not limited to the embodiments described below, and includes embodiments appropriately modified by a person skilled in the art to an obvious extent on the basis of the following embodiments. Each embodiment may be combined with a plurality of embodiments as long as the embodiments do not contradict each other. An embodiment obtained by combining one preferred embodiment and another preferred embodiment with each other is also a preferred embodiment.

The description “from A to B” as used herein, the description representing a numerical range, means “A or more and B or less.”

### (Cheese-Like Food)

A cheese like food according to one aspect of the present invention has a feature in that an abundance ratio of fat globules each having a diameter of from 7 μm to 19 μm is 30% or more, and an abundance ratio of fat globules each having a diameter of 20 μm or more thereto is less than 8%, relative to an entirety of the fat globules in the cheese-like food.

The cheese-like food of the present invention can provide a cheese-like food excellent in stringiness and heat-melting property through the adjustment of the diameters of the fat globules to be incorporated thereinto to a specific distribution.

The protein content of the cheese-like food of the present invention is, for example, 13 mass % or less, preferably from 8 mass % to 13 mass %, more preferably from 9 mass % to 12 mass %, still more preferably from 10 mass % to 12 mass %. The protein content may be analyzed by: integrating rennet casein and any other protein raw material out of raw materials to be used for manufacturing the cheese-like food, and protein contents in the respective other raw materials; or applying a Kjeldahl method to the cheese-like food.

The following has been generally found: cheese shows such a structure that fat contents (fat globules) and moisture are incorporated in a mixed manner into a network-structured matrix formed by a protein; however, when the content of the protein is small, the amount of the protein matrix reduces, and hence the cheese is reduced in hardness and stringiness, or cannot hold the fat contents (fat globules), and oil-off is liable to occur. In one embodiment, the content of a protein whose raw material cost is high in the cheese-like food of the present invention is reduced, and for example, a thickening stabilizer such as starch is used instead as a raw material. The inventors of the present invention have found that when the protein is entirely replaced with the starch at this time, stringiness (property by which the food is extended flexibly and long) like the stringing of the cheese disappears. In view of the foregoing, in one embodiment of the present invention, the inventors have found that a cheese-like food excellent in stringiness and heat-melting property can be achieved by: setting the content of the protein in the cheese-like food within a specific amount range; and adjusting the diameters of the fat globules to be incorporated thereinto to a specific distribution.

Relative to the entirety of the fat globules in the cheese-like food of the present invention, the abundance ratio of the fat globules each having a diameter of from 7 μm to 19 μm is 30% or more, and the abundance ratio of the fat globules each having a diameter of 20 μm or more thereto is less than 8%.

When the diameters of the fat globules in the cheese-like food are excessively small, no oil off at the time of the heating of the cheese-like food occurs, and hence the food is poor in delicious appearance. In addition, the stringiness of the food deteriorates. Meanwhile, when the diameters of the fat globules in the cheese like food become excessively large, oil-off at the time of the heating of the cheese-like food increases, and hence the food is poor in delicious appearance. In addition, the stringiness deteriorates. The inventors of the present invention have found that the optimization of the distribution of the diameters of the fat globules is important for achieving both of the delicious appearance and satisfactory stringiness of the cheese-like food, and have completed the present invention.

Relative to the entirety of the fat globules in the cheese-like food of the present invention, the abundance ratio of the fat globules each having a diameter of from 7 μm to 19 μm is preferably from 30% to 50%. A case in which the abundance ratio of the fat globules each having a diameter of from 7 μm to 19 μm is excessively large is not preferred in terms of product design because of the following reason: the heat-melting property of the cheese-like food deteriorates, and hence the food hardly melts even when heated, with the result that its stringiness deteriorates. Meanwhile, a case in which the abundance ratio of the fat globules each having a diameter of from 7 μm to 19 μm is excessively small is not preferred in terms of product design because the abundance ratio of the fat globules each having a larger diameter becomes relatively large, and hence oil off increases.

In one embodiment of the cheese-like food of the present invention, the abundance ratio of the fat globules each having a diameter of from 7 μm to 19 μm relative to the entirety of the fat globules in the cheese-like food is preferably 40% or more.

In addition, in one embodiment of the cheese-like food of the present invention, the abundance ratio of the fat globules each having a diameter of 20 μm or more relative to the entirety of the fat globules in the cheese-like food is preferably less than 1%.

The diameters of the fat globules in the cheese-like food and their distribution may be measured by analyzing an image of a section of the cheese-like food taken with a scanning electron microscope (SEM), and specifically, the measurement may be performed by a method described in Examples. In the present invention, the diameters of the fat globules are determined as follows: after the cheese-like food has been frozen, a structure photograph thereof is taken with a microscope system, and is captured in image processing software; and the areas of the fat globules appearing in the photograph are subjected to image analysis, and the diameters are determined from the areas of the fat globules.

The term “cheese like food” as used herein means a food, which includes rennet casein, an edible oil and fat, and water as essential components, and which is obtained by cooling and solidifying an emulsion obtained by heating and melting the mixture of these components. It can be said that the cheese-like food is a food showing flavor and mouthfeel similar to those of various kinds of cheese, such as immature natural cheese, mature natural cheese, processed cheese, or cheese food.

Examples of the raw materials for manufacturing the cheese-like food of the present invention include rennet casein, an edible oil and fat, and water serving as essential components.

The rennet casein is obtained by: adding rennet to, for example, milk, sheep milk, or goat milk, or composition modified milk or skimmed milk thereof to form curd; and then removing whey, followed by the drying of the residue. The rennet casein is commercially available in the form of powder. The content of the rennet casein is preferably 5 mass % or more with respect to the entirety of the cheese-like food, and is, for example, from 5 mass % to 14 mass %, preferably from 6 mass % to 12 mass %.

The term “powder” as used herein refers to a state in which solid fine particles aggregate, and the sizes of the fine particles are not particularly limited.

The edible oil and fat is typically, for example, a vegetable oil and fat, and examples thereof also include animal fat-derived butter, cream, lard, tallow, and fish oil. The vegetable oil and fat is preferably used from the viewpoints of an environmental load and cost. The kind of the vegetable oil and fat is not particularly limited, and there may be used, for example, corn oil, soybean oil, palm oil, palm kernel oil, linseed oil, tung oil, safflower oil, kaya oil, sunflower oil, cottonseed oil, rapeseed oil, mustard oil, sesame oil, peanut oil, olive oil, coconut oil, or rice oil.

The edible oils and fats may be used alone or in combination thereof. Not only a single oil and fat but also adjusted oils and fats obtained by combining oils and fats in a complicated manner may be used because the cheese-like food is required to have the following property: the food has hardness at the time of its cold storage, and melts when heated. Not only an oil and fat that has been extracted from a raw material and purified but also an oil and fat processed into, for example, a hydrogenated oil may be used as the edible oil and fat.

The content of the edible oil and fat is preferably 20 mass % or more with respect to the entirety of the cheese-like food, and is, for example, from 20 mass % to 50 mass %, preferably from 30 mass % to 45 mass %.

With regard to the water, the water itself may be used as a raw material, or moisture in a raw material except the water may be utilized. The content of the water is preferably 30 mass % or more with respect to the entirety of the cheese-like food, and is, for example, from 30 mass % to 70 mass %, preferably from 35 mass % to 55 mass %.

In addition, any other raw material for manufacturing the cheese like food of the present invention is, for example, a thickening stabilizer, a pH adjuster, or a seasoning to the extent that the effects of the present invention are not impaired. Those other raw materials may be used alone or in combination thereof to the extent that the effects of the present invention are not impaired, and the content thereof may be appropriately determined in consideration of purposes. Typically, the pH adjuster is a liquid, and the other raw materials are powdery solids.

The thickening stabilizer is not particularly limited, and a material that may be used in a food field may be appropriately selected and used. Examples of the thickening stabilizer include: polysaccharide thickeners, such as guar gum, tara gum, carrageenan, and locust bean gum; agar; gelatin; and starches, specifically, potato starch, sweet potato starch, tapioca starch, corn starch, waxy corn starch, sago starch, wheat starch, rice starch, bean starch, modified starch, acetylated adipic acid cross-linked starch, acetylated phosphoric acid cross-linked starch, acetylated oxidized starch, octenylsuccinic acid starch, acetic acid starch, oxidized starch, hydroxypropyl starch, hydroxypropylated phosphoric acid cross-linked starch, phosphoric acid monoesterified phosphoric acid cross-linked starch, phosphorylated starch, phosphoric acid cross-linked starch, and sodium starch glycolate.

The pH adjuster is not particularly limited, and a material that may be used in a food field may be appropriately selected and used. Examples of the pH adjuster include one kind or a plurality of kinds selected from an organic acid, an inorganic acid, and a base. Specific examples thereof include citric acid, lactic acid, succinic acid, sodium hydroxide, and potassium hydroxide.

The seasoning is not particularly limited, and a material that may be used in a food field may be appropriately selected and used. Examples of the seasoning include sodium glutamate, sodium succinate, sodium inosinate, sodium guanylate, a vegetable protein enzymatic decomposition product, an animal protein enzymatic decomposition product, a pyrazine, a peptide, Maillard peptide, a yeast extract, D/L-amino acids, salt, pepper, and a herb. Of those, a cheese enzymatic decomposition product is preferred.

In one embodiment, the cheese-like food of the present invention may include a cheese raw material, that is, natural cheese or processed cheese. The cheese raw material is solid matter, and its shape and size are not limited.

Examples of the kind of the natural cheese include cheddar cheese, pasta filata cheese, samsoe cheese, gouda cheese, edam cheese, emmental cheese, parmesan cheese, cream cheese, mildewy cheese, and blue-mold cheese. Of those, pasta filata cheese is preferred from the viewpoint of stringiness.

The degree of maturity of the natural cheese is not limited. In one embodiment, cheese matured with lactic acid bacteria alone is more preferred. Green cheese is preferred from the viewpoint of stringiness.

Processed cheese using a molten salt that hardly thickens such as sodium citrate is preferred as the processed cheese. The number of kinds of the cheese raw materials in the cheese-like food may be one or two or more.

A case in which the content of the cheese raw material is small is advantageous from the viewpoints of the alleviation of an environmental load and raw material cost. In one embodiment, when the cheese-like food of the present invention includes the cheese raw material, the content of the cheese raw material is, for example, 0.1 mass % or more, preferably 1 mass % or more, more preferably 2 mass % or more with respect to the cheese-like food. In addition, the upper limit of the content of the cheese raw material is, for example, 10 mass % or less, preferably 9 mass % or less, more preferably 8 mass % or less with respect to the cheese-like food.

The cheese-like food of the present invention may be formed into an arbitrary shape, such as a slice shape, a block shape, a dice shape, or a bar shape, as well as a shred shape.

The cheese-like food of the present invention is excellent in stringiness and heat-melting property, and in one embodiment, can further include a moderate oil-off.

The term “stringiness” as used herein means that when the cheese like food is heated, the texture of the food expresses its flexibility and elasticity, and hence the food is extended without being cut at the time of its extension. As described in Examples, the cheese-like food may be specifically evaluated for its stringiness as follows: the cheese like food is heated in a toaster oven at 1,000 W for 3 minutes, and is left standing to cool at room temperature for 30 seconds; then the cheese-like food is stirred with a fork; and the evaluation is performed by the height (cm) at which the cheese-like food is cut when the fork is lifted upward. The cheese-like food of the present invention can exhibit suitable and excellent stringiness when used in food to be cooked with heat.

The term “heat-melting property” as used herein refers to the ease with which the cheese-like food melts when heated. When the heat-melting property is excessively low, the cheese like food insufficiently melts even when heated, and hence the cheese-like food is not suitable for its originally assumed eating applications. Meanwhile, when the heat-melting property is excessively high, the cheese like food excessively melts when heated, and hence the ease with which the food is eaten is impaired, or oil-off in which an oil content floats to the surface of the food increases to impair the beauty (delicious appearance) and mouthfeel thereof. The cheese-like food is preferably brought into a moderately melted state by heating at the time of its eating. Accordingly, the heat-melting property is preferably such that the cheese-like food is brought into a moderately melted state under a general condition for the cooking of food with heat. The heat-melting property may be specifically evaluated by a method described in Examples.

The term “oil-off” as used herein means that the oil content in the cheese-like food floats to the surface of the food owing to heating. The presence of the oil-off improves the beauty of the food and allows one to feel the delicious appearance thereof. Meanwhile, when the oil-off is excessively large, the beauty (delicious appearance) is impaired, and the food becomes soggy to provide poor mouthfeel. The oil-off of the cheese-like food of the present invention is preferably from 0.4 mass % to 8 mass %. The oil-off may be measured by, for example, a method described in Examples.

The cheese-like food of the present invention may be eaten in itself, or may be used as a raw material for various products, such as cheese food, a seasoning, confectionery, prepared bread, retort food, food and drink, processed fishery food, and liquid food. The cheese-like food of the present invention may be suitably used particularly in food to be eaten after having been heated or warmed, such as pizza, gratin, hamburg or hamburger, hot dog, or prepared bread.

### (Method of Manufacturing Cheese-Like Food)

A method of manufacturing a cheese-like food according to one aspect of the present invention has a feature of including the steps of: loading a vegetable oil and fat into a melting apparatus; loading another raw material except water into the melting apparatus; stirring contents of the melting apparatus to disperse the other raw material in the vegetable oil and fat; adding water to the contents of the melting apparatus under a state in which the stirring is stopped; and heating the contents of the melting apparatus, while stirring the contents, to melt the contents.

According to the manufacturing method of the present invention, a cheese-like food, which is reduced in environmental load, and is excellent in stringiness and heat-melting property, can be manufactured at low cost and with high production efficiency.

The inventors of the present invention have found that when in a method of manufacturing a cheese-like food, any other raw material that is powder or solid matter is dispersed in an edible oil and fat, and then stirring is stopped and water is added thereto, the adhesive property of the surface of the powdery raw material can be suppressed from strengthening owing to partial hydration of the water and the powdery raw material at the time of a low water content before the completion of the water addition, and as a result, the cheese like food can be manufactured without occurrence of a “lump”. Accordingly, the method of manufacturing a cheese like food of the present invention is a low-cost and high-production efficiency manufacturing method because of the following reasons: no lump-containing product occurs, and hence a yield is high; and additional treatment for dissolving or removing a lump is not required.

In addition, according to the method of manufacturing a cheese-like food of the present invention, the cheese-like food of the present invention having the above-mentioned specific feature concerning the distribution of the diameters of its fat globules can be manufactured, and the cheese-like food can be made excellent in stringiness, heat-melting property, and oil-off.

In the method of manufacturing a cheese-like food of the present invention, first, the step of loading the edible oil and fat into the melting apparatus is performed. The edible oil and fat is preferably brought into a liquid state before the loading. The melting apparatus is an apparatus, which includes heating means and stirring means, and which can melt the mixture of the raw materials for the cheese-like food to be loaded, and an apparatus known in the art may be used.

Next, in the method of manufacturing a cheese-like food of the present invention, the step of loading the other raw material except the water into the melting apparatus is performed.

With regard to the other raw material to be loaded, a pH adjuster that is a liquid is not loaded in this step, and is added after an emulsion in which the raw materials are uniformly mixed has been obtained in the heating and melting step. In one embodiment of the present invention, the other raw material is a powdery or solid raw material. In one embodiment of the present invention, when cheese is used as a raw material for the cheese-like food, for the purpose of suppressing an increase in viscosity of the raw materials due to the loading of the cheese that is a solid, the cheese is preferably added after the emulsion in which the raw materials are uniformly mixed has been obtained in the heating and melting step.

Next, in the method of manufacturing a cheese-like food of the present invention, the step of stirring the contents of the melting apparatus to disperse the other raw material in the vegetable oil and fat is performed. The stirring only needs to be performed until the other raw material is dispersed in the edible oil and fat well, and conditions for the stirring (e.g., the number of revolutions, power, and time period of the stirring) may be appropriately determined. The number of revolutions of the stirring is, for example, from 30 rpm to 1,000 rpm, and the number of revolutions is preferably set to from 50 rpm to 300 rpm because high-speed shearing reduces the heat-melting property of the food. Heating at the time of the stirring is performed, for example, at a temperature of from 75° C. to 90° C. for from 3 minutes to 30 minutes.

Next, in the method of manufacturing a cheese-like food of the present invention, the step of adding the water to the contents of the melting apparatus under a state in which the stirring is stopped is performed.

Essentially, the words “stirring is stopped” as used herein literally mean that the stirring is stopped. However, to formally avoid correspondence to the words “stirring is stopped,” such an aspect as described below is included in the present invention: the cheese-like food is manufactured without occurrence of a “lump” as in the present invention by performing the stirring at an extremely low speed (e.g., a number of revolutions as low as about 10 rpm) during the water addition or by intermittently performing the stirring during the water addition, though the time period for which the stirring is stopped substantially constitutes most of the time period for which the water addition is performed.

Next, in the method of manufacturing a cheese-like food of the present invention, the step of heating the contents of the melting apparatus, while stirring the contents, to melt the contents is performed. The heating only needs to be performed until the raw materials for the cheese-like food in the melting apparatus melt, and conditions for the heating (e.g., a temperature and a time period) may be appropriately determined. For example, the heating may be performed so that the temperature of the raw materials for the cheese like food serving as the contents of the melting apparatus may be from 80° C. to 90° C. The stirring only needs to be performed until the raw materials for the cheese-like food in the melting apparatus are mixed well, and conditions for the stirring (e.g., the number of revolutions, power, and time period of the stirring) may be appropriately determined. In one embodiment of the present invention, the number of revolutions of the stirring is preferably set to from 50 rpm to 300 rpm. The heating and melting step can provide an emulsion in which all the raw materials for the cheese-like food are uniformly mixed. In addition, the heating and melting step can sterilize the raw materials.

After the emulsion in which all the raw materials are uniformly mixed has been obtained, the pH adjuster that is a liquid is added thereto to adjust its pH to a desired pH in the final product. The target value of the pH is, for example, from 5.0 to 6.0. In one embodiment of the present invention, the target value of the pH is preferably from 5.2 to 5.8. Thus, the stringiness of the cheese-like food to be obtained becomes more satisfactory.

Next, in the method of manufacturing a cheese-like food of the present invention, the emulsion serving as a raw material for the cheese like food is loaded into a mold and cooled to provide a molded cheese-like food. The shape and dimensions of the mold may be appropriately determined. The molded cheese-like food may be further processed into an arbitrary shape, such as a shred shape, a slice shape, a block shape, a dice shape, or a bar shape.

### EXAMPLES

The present invention is more specifically described below by way of Examples. However, the scope of the present invention is by no means limited to the description of these Examples.

In the following Examples, cheese-like foods were manufactured by various manufacturing methods while the composition of raw materials to be used was changed, and the foods were each evaluated for its quality.

### (Used Raw Material)

The raw materials used in the following Examples are as described below.

Vegetable oil and fat: mixed oil containing palm oil and palm kernel oil (manufactured by Taiyo Yushi Corp.)

Rennet casein (manufactured by Fonterra Co-operative Group Limited)

Sodium caseinate (manufactured by Fonterra Co-operative Group Limited)

Modified starch: phosphoric acid cross-linked starch (manufactured by Matsutani Chemical Industry Co., Ltd.)

Natural cheese: cream cheese (manufactured by Fonterra Co-operative Group Limited)

Polysaccharide thickener and agar serving as stabilizers
Polysaccharide thickener: mixed material of guar gum and tara gum, locust bean gum, and carrageenan (all of which are manufactured by San-Ei Gen F.F.I., Inc.)
Agar (manufactured by Ina Food Industry Co., Ltd.)

Seasoning or the like: sodium glutamate (manufactured by ShoEi Foods Corporation), salt (manufactured by Shizuoka Engyo Co., Ltd.), and lactic acid (manufactured by Musashino Chemical Laboratory, Ltd.)

### (Evaluation Method)

Cheese-like foods obtained in Examples and Comparative Examples were evaluated by the following evaluation methods.

### <Method of Evaluating Diameters of Fat Globules>

Each of the resultant cheese-like foods was loaded into liquid nitrogen to be frozen. After that, the frozen food was cut into a small piece measuring about 3 mm long by about 3 mm wide by about 2 mm high. Structure photographs of the small piece were taken with a low-vacuum SEM (Hitachi desktop electron microscope system, model: TM3030 Plus) at an acceleration voltage of DC 15 KV and a shooting magnification of 1,000. One representative photograph out of the taken structure photographs was selected and captured in ImageJ image processing software (v. 1.53), and the areas of fat globules appearing in the photograph were subjected to image analysis, followed by the determination of their diameters from the areas of the fat globules. Specifically, such binarization that the fat globules were selected was performed in accordance with the manual of the software, and the areas of all the visible fat globules were calculated, followed by the calculation of their diameters from the areas on the assumption that the fat globules were spheres. A histogram of the diameters of the fat globules was produced by utilizing the Excel software of Microsoft Corporation, and the distribution of the diameters of the fat globules was determined from the histogram.

### <Methods of Evaluating Stringiness and Oil-Off>

Each of the resultant cheese-like foods was shredded into a shape measuring from 5 mm to 10 mm wide by from 10 mm to 20 mm long by from 1 mm to 2 mm thick, and 25 g of the resultant fine piece was collected in an aluminum dish, followed by its heating together with the aluminum dish in a toaster oven at 1,000 W for 3 minutes. After having been left standing to cool at room temperature for 30 seconds, the cheese-like food was stirred with a fork, and the fork was lifted upward. The height at which the cheese-like food was cut was measured. The measurement was performed for each sample three times, and the average of the measured values was defined as stringiness (cm). When the stringiness was 10 cm or more, the stringiness was evaluated to be satisfactory.

In addition, an oil floating to the surface of the cheese-like food after the heating in the toaster oven was dropped onto a balance, and its weight was measured. A ratio (mass %) was determined by dividing the measured oil weight by the weight (25 g) of the cheese-like food collected in the aluminum dish. The measurement was performed for each sample twice, and the average of the measured values was defined as an oil-off (mass %).

### <Method of Evaluating Heat-Melting Property>

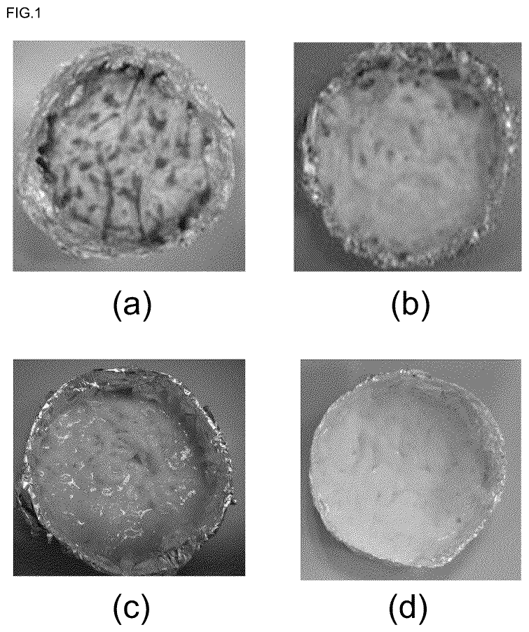

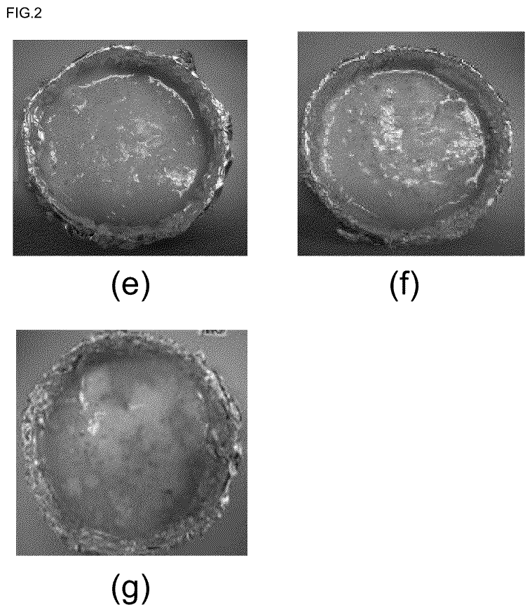

25 Grams of each of the resultant cheese-like foods was collected in an aluminum dish, and was heated together with the aluminum dish in a toaster oven at 1,000 W for 3 minutes. With regard to the state of the cheese-like food after the heating, its melting property was evaluated on a seven-point scale of from 1 point to 7 points in accordance with the following evaluation criteria. For reference, respective states corresponding to from 1 point to 7 points are shown in (a) to (g) of FIG. 1 and FIG. 2. When the heat-melting property was from 3 points to 5 points, the heat-melting property was evaluated to be satisfactory.

### Evaluation Criteria

1 point: A state in which the cheese-like food does not melt, and is burnt.
2 points: A state in which the melting residue of the cheese-like food is present, and the burning thereof occurs.
3 points: A satisfactory state. A state in which substantially no oil-off is present, but the melting residue of the cheese-like food is absent, and the burning thereof is also absent.
4 points: The best state. A state in which the cheese-like food melts, but does not completely melt, and hence the food is muddy and has fluidity.
5 points: A satisfactory state. A state in which oil-off is observed, and the cheese-like food melts, but does not completely melt, and hence has moderate fluidity.
6 points: Oil-off is remarkable. A state in which the cheese-like food melts.
7 points: Oil-off is extremely remarkable. A state in which the cheese-like food melts in a substantially complete manner to be brought into a liquid state.

### <Method of Evaluating Shredding Suitability>

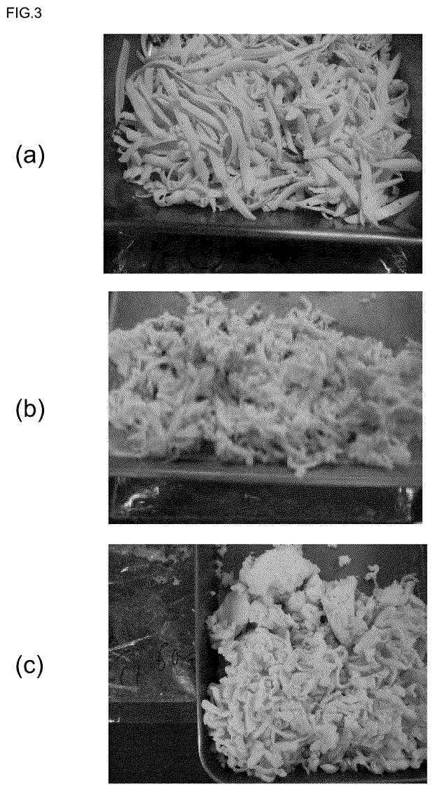

50 Grams of a block of each of the resultant cheese-like foods was collected, and was shredded with a cheese grater. With regard to the state of the cheese-like food after the shredding, its shredding suitability was evaluated on a five-point scale of from 1 point to 5 points in accordance with the following evaluation criteria. For reference, states corresponding to 5 points, 3 points, and 1 point are shown in (a) to (c) of FIG. 3, respectively. When the shredding suitability was from 3 points to 5 points, the shredding suitability was evaluated to be satisfactory.

### Evaluation Criteria

1 point: Extremely unsatisfactory (terrible binding is observed.)
2 points: Unsatisfactory
3 points: The limit at which the cheese-like food is acceptable as a commercial product, though partial binding is observed.
4 points: Satisfactory
5 points: Extremely satisfactory (the cheese-like food can be beautifully shredded.)

### (Manufacturing Example of Cheese-Like Food)

### Examples 1 to 5 and Comparative Examples 1 and 2

A block-shaped cheese-like food was manufactured by using raw materials shown in Table 1. First, a vegetable oil and fat was loaded into a kettle type emulsifier having a volume of 5 L, and then other raw materials except water were added thereto. The contents of the emulsifier were stirred at from 50 rpm to 100 rpm so that the other raw materials were uniformly dispersed in the vegetable oil and fat. The term “other raw materials” as used herein refers to rennet casein, sodium caseinate, modified starch, natural cheese, a stabilizer, and a seasoning. The stirring was stopped, and the water was added to the mixture, followed by heating and melting while the contents of the emulsifier were stirred at from 100 rpm to 200 rpm. At the stage at which the temperature of the raw material mixture became from 80° C. to 90° C., lactic acid was added thereto in such an amount that the pH value of the final product was adjusted to 5.5. Thus, an emulsion in which the raw materials were uniformly mixed was obtained.

With regard to each of Examples and Comparative Examples in Table 1, when the integration of moisture, a protein, a fat, the rennet casein, and a carbohydrate out of nutritional components does not reach 100 mass %, the remaining component is an ash content.

The resultant emulsion was filled into a container measuring about 55 mm long by about 110 mm wide by about 35 mm high, and was loaded into a refrigerator having an internal temperature of about 4° C. The resultant product was molded by being cooled until its temperature became about 4° C. Thus, the block-shaped cheese-like food was obtained. The food was used as a sample and evaluated by the above-mentioned evaluation methods. The evaluation results are shown in Table 2.

TABLE 1

| Raw material | | | | | | Comparative | Comparative | Comparative | Comparative |
|---|---|---|---|---|---|---|---|---|---|
| (mass %) | Example 1 | Example 2 | Example 3 | Example 4 | Example 5 | Example 1 | Example 2 | Example 3 | Example 4 |
| Vegetable oil and fat | 34.1 | 35.9 | 37.5 | 39.1 | 39.3 | 29.8 | 25.4 | 34.3 | 39.1 |
| Rennet casein | 8.2 | 8.6 | 9.7 | 9.4 | 9.4 | 14.9 | 4.8 | 8.2 | 9.4 |
| Sodium caseinate | 3.3 | 3.4 | 3.9 | 3.7 | 3.8 | 0 | 1.9 | 3.3 | 3.7 |
| Modified starch | 1.4 | 1.4 | 1.6 | 1.6 | 1.6 | 3.0 | 17.5 | 1.4 | 1.6 |
| Natural cheese | 3.3 | 0 | 1.6 | 1.5 | 1.5 | 3.3 | 3.8 | 3.3 | 1.5 |
| Sodium citrate | 0.4 | 0.3 | 0.7 | 0.7 | 0.3 | 0.9 | 0.3 | 0.4 | 0.7 |
| Stabilizer (polysaccharide | 1.2 | 1.0 | 0.4 | 0.4 | 0.4 | 0.3 | 0.3 | 0.8 | 0.4 |
| thickener or agar) | | | | | | | | | |
| Guar gum or tara gum | 0.10 | 0 | 0.10 | 0.10 | 0.10 | 0.10 | 0.10 | 0.10 | 0.10 |
| Carrageenan | 0.15 | 0.10 | 0.15 | 0.15 | 0.15 | 0.10 | 0.10 | 0.15 | 0.15 |
| Locust bean gum | 0.15 | 0.10 | 0.15 | 0.15 | 0.15 | 0.10 | 0.10 | 0.15 | 0.15 |
| Agar | 0.80 | 0.80 | 0 | 0 | 0 | 0 | 0 | 0.40 | 0 |
| Seasoning or the like | 4.0 | 3.7 | 5.8 | 4.8 | 4.8 | 4.4 | 3.9 | 4.2 | 4.7 |
| Water | 44.1 | 45.7 | 38.8 | 38.8 | 38.9 | 43.4 | 42.1 | 44.1 | 38.9 |
| Total | 100 | 100 | 100 | 100 | 100 | 100 | 100 | 100 | 100 |
| Nutritional component | | | | | | | | | |
| (mass %) | | | | | | | | | |
| Moisture | 48.0 | 48.0 | 42.0 | 42.0 | 42.0 | 48.0 | 48.0 | 48.0 | 42.0 |
| Protein | 10.6 | 10.4 | 11.4 | 11.4 | 11.5 | 13.2 | 6.6 | 10.6 | 11.4 |
| Fat | 35.0 | 36.0 | 39.7 | 39.7 | 40.0 | 30.5 | 26.6 | 35.2 | 39.7 |
| Rennet casein | 8.5 | 8.6 | 9.9 | 9.5 | 9.6 | 15.2 | 5.2 | 8.5 | 9.5 |
| Carbohydrate | 3.2 | 2.8 | 3.5 | 3.5 | 3.2 | 4.4 | 16.2 | 3.0 | 3.5 |

TABLE 2

| Evaluation | Example | Example | Example | Example | Example | Comparative | Comparative | Comparative | Comparative |
|---|---|---|---|---|---|---|---|---|---|
| result | 1 | 2 | 3 | 4 | 5 | Example 1 | Example 2 | Example 3 | Example 4 |
| Fat globules each having | 63.2 | 60.8 | 59.9 | 55.7 | 55.4 | 84.4 | 32.5 | 72.3 | — |
| globule diameter of | | | | | | | | | |
| 6 μm or less (%) | | | | | | | | | |
| Fat globules each having | 36.8 | 38.2 | 40.1 | 43.2 | 44.3 | 15.6 | 57.5 | 27.7 | — |
| globule diameter of | | | | | | | | | |
| 7 μm to 19 μm (%) | | | | | | | | | |
| Fat globules each having | 0.0 | 1.0 | 0.0 | 1.1 | 0.3 | 0.0 | 10.0 | 0.0 | — |
| globule diameter of | | | | | | | | | |
| 20 μm or more (%) | | | | | | | | | |
| Stringiness (cm) | 20 | 30 | 28 | 35 | 28 | 16 | 0 | 3 | — |
| Oil-off (mass %) | 0.8 | 1.2 | 0.8 | 2.0 | 0.4 | 0 | 10.0 | 0 | 0 |
| Shredding suitability | 3 | 3 | 5 | 4 | 5 | 4 | 5 | 4 | — |
| Heat-melting property | 5 | 5 | 5 | 4 | 3 | 2 | 6 | 2 | — |
| Presence or absence | absent | absent | absent | absent | absent | present | absent | present | — |
| of melting residue | | | | | | | | | |

With regard to each of Examples 1 to 5 and Comparative Examples 1 and 2, a “lump” due to the fact that a powdery or solid raw material was not dissolved was not observed in the emulsion obtained in the manufacturing process.

In each of Examples 1 to 5, the ratio of the fat globules each having a diameter of from 7 μm to 19 μm to the entirety of the fat globules was 30% or more, and the ratio of the fat globules each having a diameter of 20 μm or more to the entirety of the fat globules was less than 8%. At this time, the heat-melting property was from 3 points to 5 points, that is, satisfactory, and the oil-off was from 0.4 mass % to 1.2 mass %, that is, satisfactory. In addition, the stringiness was 10 cm or more, that is, satisfactory. In addition, the shredding suitability was 3 points or more, that is, satisfactory.

In Comparative Example 1, the stringiness was 10 cm or more, and hence the stringiness was satisfactory. However, the ratio of the fat globules each having a diameter of 6 μm or less was 80% or more, and hence a melting residue was observed at the time of the evaluation of the heat-melting property. It is found that when many fat globules having small diameters are present, a cheese-like food hardly melts even when heated because its raw materials are liable to be emulsified. In addition, the oil-off was 0 mass %, and hence the heat-melting property was poor. The shredding suitability was 3 points or more, that is, satisfactory.

In Comparative Example 2, the ratio of the fat globules each having a diameter of from 7 μm to 19 μm was 57.5%, and the ratio of the fat globules each having a diameter of 20 μm or more was 10%. Accordingly, the oil-off was extremely as high as 10 mass %, and hence the heat-melting property was poor. It is found that when many fat globules having large diameters are present, a cheese like food is liable to melt when heated because its raw materials are hardly emulsified, with the result that its oil-off increases. In addition, stringiness was absent. The shredding suitability was 3 points or more, that is, satisfactory.

In each of Comparative Examples 1 and 2, no suitable effects were obtained in the evaluations of the resultant cheese-like food as compared to Examples 1 to 5, though the method of manufacturing a cheese-like food was the same as those of Examples 1 to 5. The reason why the effects are not obtained in Comparative Example 1 is assumed as follows: the protein content is relatively as large as 13.2 mass %, and hence a protein network becomes dense and the fat globules are taken in the dense network, with the result that the diameters of the fat globules reduce to preclude the achievement of a suitable distribution of the diameters of the fat globules. In contrast, the reason why the effects are not obtained in Comparative Example 2 is assumed as follows: the protein content is relatively as small as 6.6 mass %, and hence the diameters of the fat globules increase to preclude the achievement of a suitable distribution of the diameters of the fat globules.

### Comparative Example 3

A block-shaped cheese-like food was manufactured by using raw materials shown in Table 1. First, all the raw materials were loaded into MILLSER (manufactured by Iwatani Corporation, IFM-650D), and were stirred at about 20,000 rpm for about 30 seconds to provide a raw material mixture in which the raw materials were uniformly mixed. The raw material mixture was transferred to an emulsifier having a volume of 1.5 liters (manufactured by Takara Kasei Kiki Co., Ltd., cheese kneader “TA-26”), and was heated and melted while being stirred in the emulsifier at from 200 rpm to 250 rpm. At the stage at which the temperature of the raw material mixture became from 80° C. to 90° C., lactic acid was added thereto in such an amount that the pH value of the final product was adjusted to 5.5. Thus, an emulsion in which the raw materials were uniformly mixed was obtained.

The resultant emulsion was filled into a container measuring about 55 mm long by about 110 mm wide by about 35 mm high, and was loaded into a refrigerator having an internal temperature of about 4° C. The resultant product was molded by being cooled until its temperature became about 4° C. Thus, the block-shaped cheese-like food was obtained. The food was used as a sample and evaluated by the above-mentioned evaluation methods. The evaluation results are shown in Table 2.

A “lump” due to the fact that a powdery or solid raw material was not dissolved was not observed in the cheese-like food obtained in Comparative Example 3.

The ratio of the fat globules each having a diameter of from 7 μm to 19 μm was 27.7%, and the stringiness was as low as 3 cm. A melting residue was observed at the time of the evaluation of the heat-melting property. In addition, no oil-off was observed, and hence the heat-melting property was poor. The shredding suitability was 3 points or more, that is, satisfactory. The cheese-like food obtained by the manufacturing method of Comparative Example 3, which included mixing all the raw materials in one stroke at a high number of revolutions of stirring, and then heating and melting the mixture, was poor in heat-melting property.

### Comparative Example 4

A block-shaped cheese-like food was manufactured by using raw materials shown in Table 1. First, a vegetable oil and fat was loaded into a kettle-type emulsifier having a volume of 3 kg (manufactured by Nichiraku Machinery Co., Ltd., 3 kg B kettle emulsifier), and then other raw materials were added thereto. The raw material mixture was heated and melted while the contents of the emulsifier were stirred at from 100 rpm to 200 rpm. At the stage at which the temperature of the raw material mixture became from 80° C. to 90° C., lactic acid was added thereto in such an amount that the pH value of the final product was adjusted to 5.5. Thus, an emulsion in which the raw materials were uniformly mixed was obtained.

The resultant emulsion was filled into a container measuring about 55 mm long by about 110 mm wide by about 35 mm high, and was loaded into a refrigerator having an internal temperature of about 4° C. The resultant product was molded by being cooled until its temperature became about 4° C. Thus, the block-shaped cheese like food was obtained. As a result of the observation of the resultant block-shaped cheese-like food, a “lump” due to the fact that a powdery or solid raw material was not dissolved was observed. Accordingly, the food was judged to be unsuitable as a sample to be subjected to a quality evaluation, and hence no evaluation was performed.

A powdery raw material reacts with water. Accordingly, when all the raw materials were added and mixed together to the oil and fat without dispersion of the powdery raw material in the oil and fat in advance, a struggle for the water occurred in the massive portion of the powdery raw material. Probably as a result of the foregoing, the amount of the water became insufficient to cause the lump.

### INDUSTRIAL APPLICABILITY

The cheese-like food of the present invention is significant in that the food is excellent in stringiness and heat-melting property, and may be suitably used in food to be eaten after having been heated.

The method of manufacturing a cheese-like food of the present invention is significant in that a cheese-like food, which is reduced in environmental load, and is excellent in stringiness and heat-melting property, can be manufactured at low cost and with high production efficiency.

Some embodiments and/or Examples of the present invention have been described in detail above, but a person skilled in the art could easily make various modifications to these illustrative embodiments and/or Examples without substantially departing from the novel teachings and effects of the present invention. Accordingly, those various modifications are encompassed in the scope of the present invention.

The literatures described in this description and the contents of the application on the basis of which the present application claims Paris convention priority are incorporated herein by reference in their entirety.

1. A cheese-like food, comprising fat globules,
wherein an abundance ratio of fat globules each having a diameter of from 7 μm to 19 μm is 30% or more, and an abundance ratio of fat globules each having a diameter of 20 μm or more thereto is less than 8%, relative to an entirety of the fat globules in the cheese-like food.

2. The cheese-like food according to claim 1, wherein a protein content of the cheese-like food is 13 mass % or less.

3. The cheese-like food according to claim 1, wherein an oil-off of the cheese-like food is from 0.4 mass % to 8 mass %.

4. A method of manufacturing a cheese-like food, comprising the steps of:
loading a vegetable oil and fat into a melting apparatus;
loading another raw material except water into the melting apparatus;
stirring contents of the melting apparatus to disperse the another raw material in the vegetable oil and fat;
adding water to the contents of the melting apparatus under a state in which the stirring is stopped; and
heating the contents of the melting apparatus, while stirring the contents, to melt the contents.

5. The manufacturing method according to claim 4, wherein an abundance ratio of fat globules each having a diameter of from 7 μm to 19 μm is 30% or more, and an abundance ratio of fat globules each having a diameter of 20 μm or more thereto is less than 8%, relative to an entirety of fat globules in the cheese-like food.

6. The manufacturing method according claim 4, wherein a protein content of the cheese-like food is 13 mass % or less.

7. The manufacturing method according to claim 4, wherein the another raw material is a powdery or solid raw material.

8. The manufacturing method according to claim 4, wherein the another raw material is rennet casein, sodium caseinate, and modified starch.

9. The manufacturing method according to claim 4, wherein the another raw material further contains natural cheese.
